(19) United States
(12) Patent Application Publication
(10) Pub. No.: US 2025/0196590 A1
(43) Pub. Date: Jun. 19, 2025

(54) A MOTOR-VEHICLE DASHBOARD, AIR VENT AND RELATIVE POSITIONING ADAPTER BODY

(71) Applicant: Stellantis Europe S.p.A., Torino (IT)

(72) Inventor: Francesco BATTISTA, Torino (IT)

(73) Assignee: Stellantis Europe S.p.A., Torino (IT)

(21) Appl. No.: 18/849,794

(22) PCT Filed: Apr. 4, 2023
(86) PCT No.: PCT/IT2023/050097

§ 371 Date: Sep. 23, 2024

(30) Foreign Application Priority Data
Apr. 12, 2022 (IT) 102022000007235

(51) Int. Cl. B60H 1/34; B60K 37/00

(52) U.S. Cl. CPC B60H 1/3435; B60H 2001/3492; B60K 37/00; B60K 2360/658

(57) ABSTRACT

A motor-vehicle dashboard includes a shaped support body having at least one fixing seat for positioning and fixing a ventilation unit arranged for providing an airflow towards the motor-vehicle interior, and a positioning adapter body rigidly connected to the shaped support body at the fixing seat, and arranged to selectively receive said ventilation unit. The positioning adapter body is a ring-shaped support flange having a main opening and fastening and support elements for rigidly and coaxially connecting the positioning adapter body to the seat and the ventilation unit to the positioning adapter body.

### FIELD OF THE INVENTION

The present invention generally relates to the field of motor-vehicle interiors and more particularly it relates to a solution for mounting the air vents of a motor-vehicle dashboard.

### PRIOR ART

As known, motor-vehicle interiors have an instrument-holder dashboard designed to arrange various components/instruments, such as, for example, finishing panels, push-button panels, adjustment cursors, the instrument panel, the radio/satellite navigation system, etc. The dashboard is also provided with at least one air vent connected to a heating and air conditioning system. The vent comprises an emission channel for an airflow and means for controlling the direction of the outflow.

Typically, the vents are hooked to support inserts embedded within the structure of the dashboard comprising a support body generally made of plastic material, and possibly a coating layer. Document FR 3 006 981 B1 illustrates a solution for arranging air vents integrated into the dashboard, which makes it possible to secure the vent to the dashboard in the event of activation of the airbag safety device.

The present invention starts from the desire to propose a motor-vehicle dashboard and a relative solution for mounting the air vents, which is equally applicable on different motor-vehicle models, defining different overall dimensions and installation spaces, using air vents of the same type and size.

### OBJECT OF THE INVENTION

The object of the present invention is to make a dashboard available inside the passenger compartment of a motor-vehicle, which bears a constructive solution that is particularly flexible, allowing the mounting of air vents of the same type on different dashboards with different dimensions and installation spaces.

A further object of the invention is to provide this solution with relatively simple to implement and low-cost means.

A further object of the invention is to provide this solution with means that ensure the strength and reliability of the components.

### SUMMARY OF THE INVENTION

These aims are achieved by means of a motor-vehicle dashboard, comprising:
a shaped support body provided with at least one fixing seat for positioning and fixing a ventilation unit arranged for providing an airflow towards the motor-vehicle interior,
wherein said ventilation unit comprises a support and flow-guide body, an air vent and adjustment means for adjusting the direction of the airflow,
a positioning adapter body rigidly connected to the shaped support body at the fixing seat, and arranged to selectively receive said ventilation unit,
wherein the positioning adapter body is a ring-shaped support flange comprising a main opening and a plurality of fastening and support elements for rigidly and coaxially connecting the positioning adapter body to the seat and the ventilation unit to the positioning adapter body, so that the support body protrudes inwards of the dashboard, through the main opening of the positioning adapter body,
wherein the positioning adapter body comprises a main ring portion from which a plurality of extension portions extend, provided with said fastening and support elements,
wherein the positioning adapter body comprises respective grooves provided along the circumferential surface defining the main opening and arranged for centering the ventilation unit within the main opening.
wherein the positioning adapter body comprises a plurality of centering holes along the extension portions, arranged to selectively receive respective centering elements of the support body,
wherein the positioning adapter body comprises a plurality of fastening holes arranged to receive respective fastening elements of the support body,
wherein the positioning adapter body defines an abutment and fixing surface for the air vent, so as to enable assembling of ventilation units of the same type on different dashboards defining different dimensions and installation spaces.

Further advantageous characteristics of the invention are defined in the attached claims and in the description that follows.

The embodiments also relate to a method for assembling an air vent on a motor-vehicle dashboard according to the characteristics mentioned above.

### BRIEF DESCRIPTION OF THE FIGURES

Further characteristics and advantages of the invention will become apparent from the description that follows with reference to the attached drawings, provided purely by way of non-limiting example, wherein:

FIG. 1 is a perspective view of a motor-vehicle instrument-holder dashboard, according to a preferred embodiment,

FIG. 2 is an exploded perspective view that illustrates some components of the previous Figure,

FIGS. 3, 4 are perspective views from different angles of a positioning adapter body for an air vent, according to an embodiment of the invention,

FIG. 5 is a perspective view illustrating the adapter body in the condition installed on the dashboard,

FIG. 6 is an exploded perspective view showing the air vent and the adapter body integrated in the dashboard,

FIG. 7 is a front view illustrating the embodiment of FIG. 6 in the assembled condition, and

FIG. 8 is a cross-sectional view along the line I-I of FIG. 1,

### DETAILED DESCRIPTION OF MORE EMBODIMENTS

In the following description various specific details are illustrated aimed at a thorough understanding of examples of one or more embodiments. The embodiments can be implemented without one or more of the specific details, or with other methods, components, materials, etc. In other cases, known structures, materials, or operations are not shown or described in detail to avoid obscuring various aspects of the embodiments. The reference to “an embodiment” in the context of this description indicates that a particular configuration, structure or characteristic described in relation to the embodiment is included in at least one embodiment. Therefore, phrases such as “in an embodiment”, possibly present in different places of this description do not necessarily refer to the same embodiment. Moreover, particular conformations, structures or characteristics can be combined in a suitable manner in one or more embodiments and/or associated with the embodiments in a different way from that illustrated here, for example, a characteristic here exemplified in relation to a figure may be applied to one or more embodiments exemplified in a different figure.

The references illustrated here are only for convenience and do not therefore delimit the field of protection or the scope of the embodiments.

Reference 1 indicates—as a whole—a motor-vehicle interior instrument-holder dashboard. The instrument-holder dashboard 1 is mounted, in use, on a suitable support structure (not shown) carried by a portion of the chassis of the motor-vehicle (not shown). The dashboard 1 extends across the entire width of the passenger compartment of the motor-vehicle and is modeled to perform various functions, including making the instrument panel available for use, along with various push-button panels, adjustment cursors, the radio/satellite navigator system, etc. The dashboard 1 may be formed by an injection molded shell body, in plastic material, optionally covered in polyvinyl chloride (PVC) or polyurethane (PU) or thermoplastic polyolefin (TPO) or leather, etc.

In the attached drawings, reference 4 indicates—as a whole—a ventilation unit supported by the dashboard 1 and arranged to direct an airflow towards the inside of the motor-vehicle, in particular towards the passengers. The unit 4 comprises an air vent 5 and adjustment means 6 for autonomously adjusting the direction of the flow; the air vent 5 comprises a support and guide body 18, substantially cylindrical in shape, arranged to channel an airflow towards the outlet of the vent 5. The dashboard 1 comprises respective ventilation units 4 arranged on the driver's side and on the passenger side; the invention is equally applicable to both units 4.

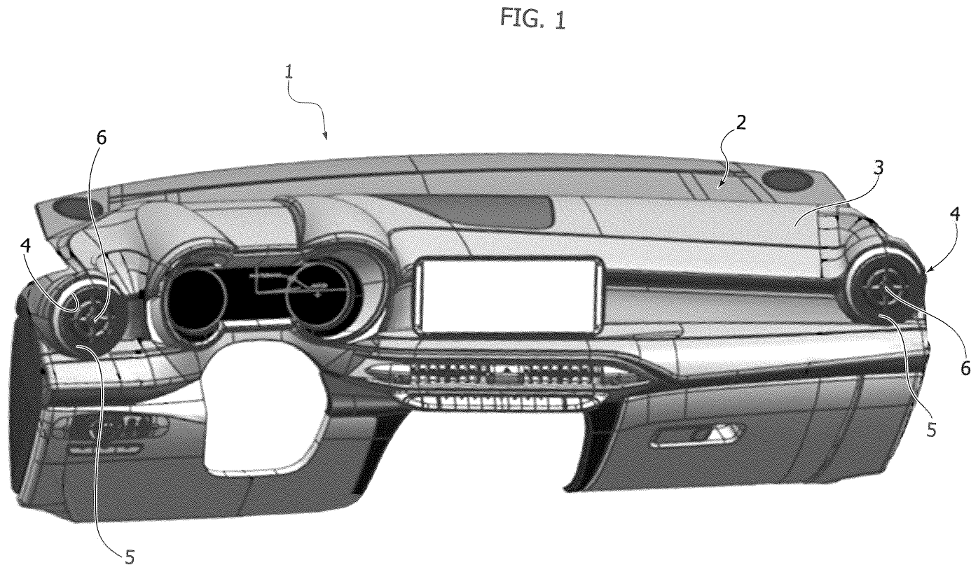

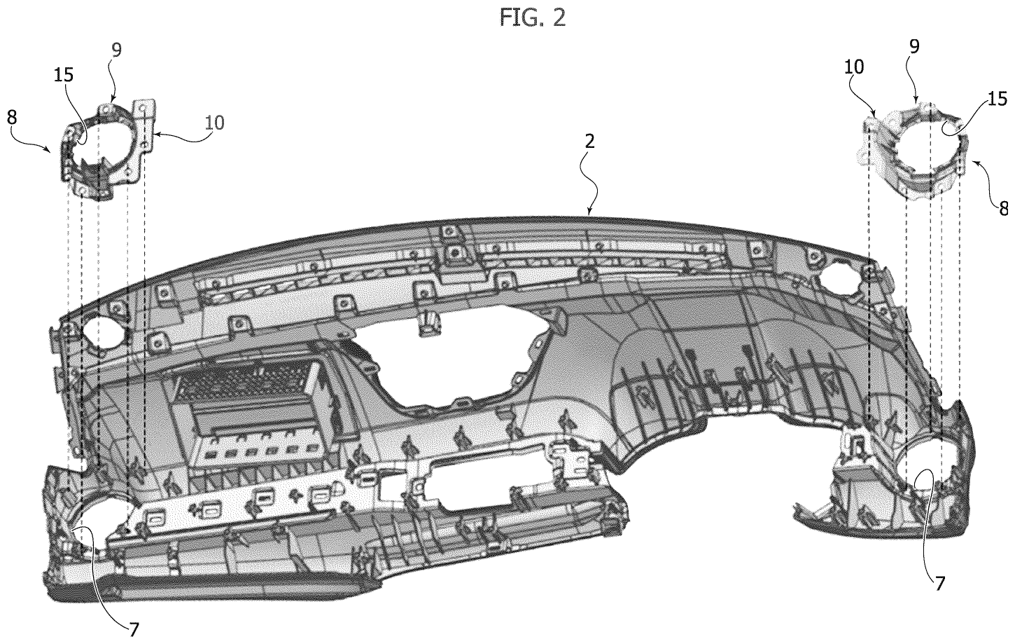

As illustrated in FIG. 2, the instrument-holder dashboard 1 essentially comprises a shaped support body 2, preferably made of plastic material, which is provided with suitable fastening elements, such as pins and centering elements, capable of allowing the correct positioning and fastening of the shaped support body on a support structure not illustrated. The shaped support body 2 may be formed in one piece or from several parts suitably coupled together. FIG. 2 shows an example of a shaped support body 2 comprising a passenger side portion, a central portion including a central compartment arranged for the installation of an infotainment system, and a peripheral portion on the driver's side. As known, the dashboard 1 may comprise decorative panels and/or finishing elements 3 (illustrated in FIG. 1) applied to the shaped support body 2, so as to give the instrument-holder dashboard 1 the required aesthetic connotation according to the motor-vehicle model.

Returning to the ventilation units 4, the shaped support body 2 comprises peripheral portions wherein fixing seats 7 are obtained for respectively positioning and fixing a ventilation unit 4.

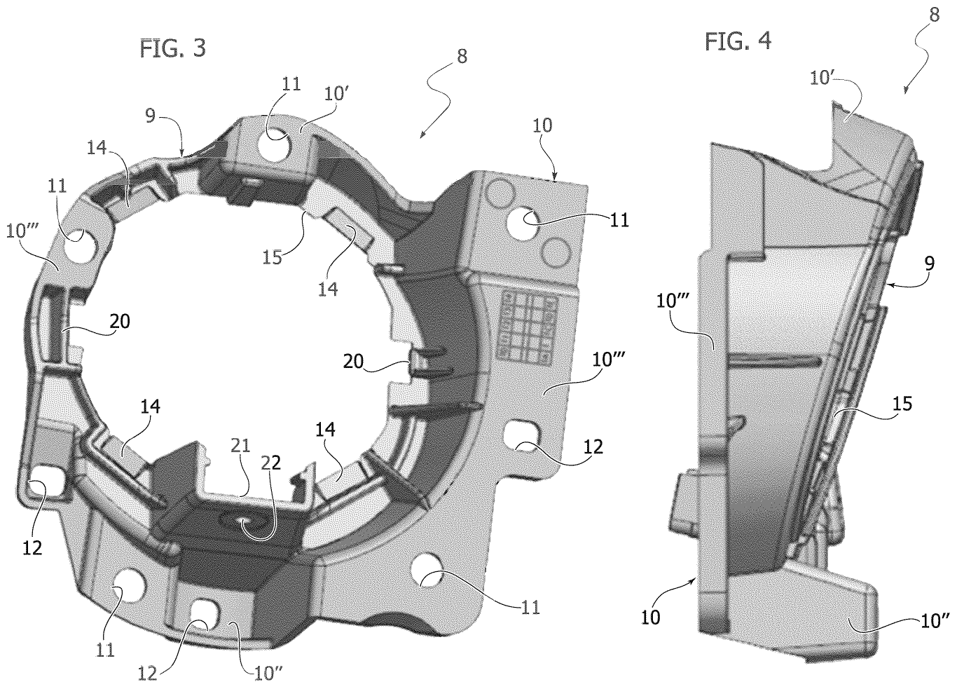

According to an important characteristic of the invention, the motor-vehicle dashboard 1 comprises a positioning adapter body 8 rigidly connected to the fixing seat 7 and arranged to selectively receive and block a ventilation unit 4. As illustrated in FIGS. 3, 4, the positioning adapter body 8 is a ring-shaped support flange, comprising a main opening 15 and a plurality of fastening and support elements—described below—obtained along the surfaces of the adapter body 8, to rigidly connect and lock the ventilation unit 4 to the adapter body 8 and into the seat 7. In other words, according to the invention, the ventilation unit 4 is indirectly connected to the shaped support body 2, since it is connected to the positioning adapter body 8, which is in turn fixed at the seat 7 of the shaped support body 2.

In one or more embodiments, the positioning adapter body 8 is shaped in a single piece of polypropylene (for example, polypropylene with mineral—talc “PP TD25”), so as to be particularly light and—at the same time—resistant. Alternatively, the positioning adapter body 8 is made of polycarbonate, for example, polycarbonate/acrylonitrile-butadiene-styrene (“PC+ABS”). Preferably, the adapter body has a total weight of about 0.05 kg.

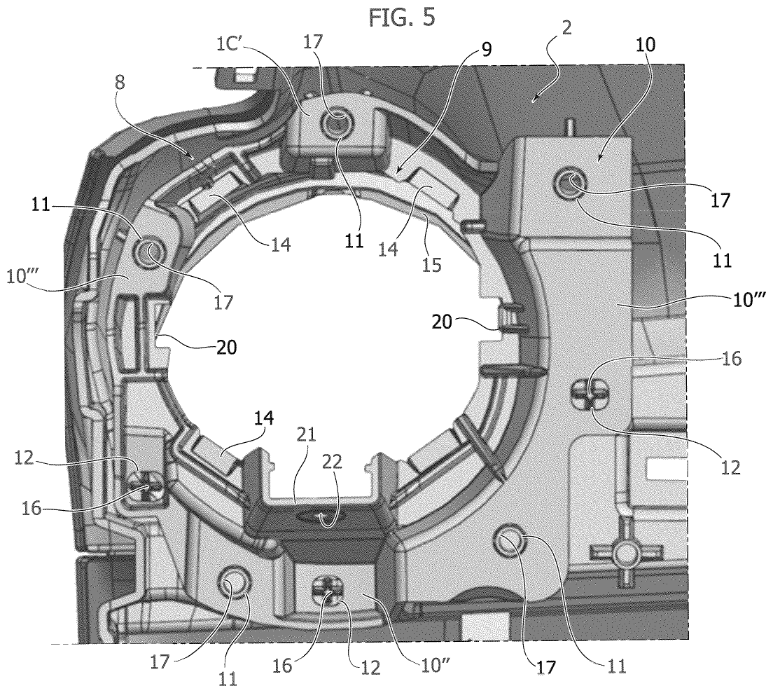

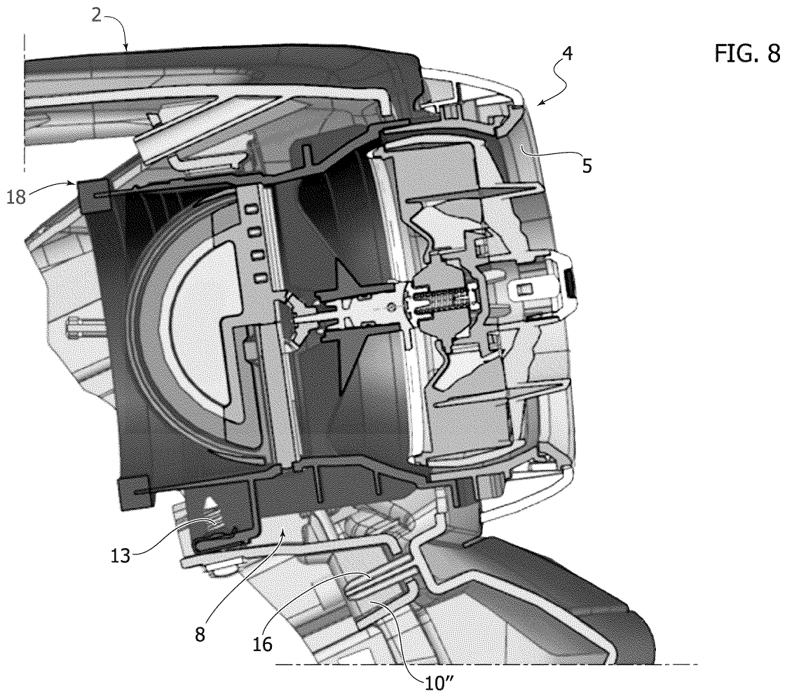

According to the assembled configuration illustrated in FIGS. 5-8, the ventilation unit 4 is coaxially connected within the seat 7 and the main opening 15 of the positioning adapter body 8, so that the support and guide body 18 projects towards the inside of the dashboard 1, through the positioning adapter body 8. In the assembled configuration illustrated in particular in the cross-sectional view of FIG. 8 (cross-section along the line I-I of FIG. 1), the positioning adapter body 8 defines an abutment surface for the vent 5, which is located on a different plane with respect to a plane defining the seat 7. As is evident, the plane is in a more external position (towards the outer front surface of the dashboard 1) with respect to the plane of the seat 7.

As indicated above, the positioning adapter body 8 is a ring-shaped support flange, comprising a main opening 15 and a plurality of fastening and support elements. More specifically, the positioning adapter body 8 comprises a ring-shaped main portion 9 from which a plurality of extension portions 10 extend, equipped with various fastening and support points. The main ring portion 9 comprises a plurality of reinforcing ribs and various seats arranged to receive the support and guide body 18 of the air vent 5. In more detail, the extension portions 10 have respective front surfaces offset with respect to the surface defining the main ring portion 9. In one or more embodiments, the positioning adapter body 8 comprises upper and lower extension portions 10′, 10″, wherein the terms upper and lower refer to an assembled condition of the adapter body 8 and of the ventilation unit 4 within the dashboard 1, as shown in FIG. 1. The lower extension portion 10″ comprises a body substantially protruding towards the outer surface of the shaped support body 2 (FIG. 8). Furthermore, the adapter body 8 comprises lateral extension portions 10″, so as to form a single continuous body with extension portions arranged around the ring portion 9.

FIG. 5 is a front view illustrating the positioning adapter body 8 fixed on the shaped support body 2 at the seat 7. In this regard, the positioning adapter body 8 has, along the extension portions 10′, 10″, 10″′, a plurality of centering holes 12, arranged to selectively receive respective centering elements 16 of the support body 2 (for example, integrated in the shaped support body 2). In accordance with the illustrated embodiment, the centering holes 12 are obtained on the lower and lateral extension portions 10″,10″′. Preferably the lower extension portion 10″ comprises a central centering hole 12 and the lateral portions 10″′ have, respectively, a centering hole 12, arranged at the sides of the central hole 12 at different heights. Furthermore, the positioning adapter body 8 comprises a plurality of fixing holes 11 arranged to receive respective fastening elements 17 of the body 2 (for example, integrated in the shaped support body 2). Preferably, the fastening elements 17 are welded to the positioning adapter body 8, at the fastening points 11. According to the illustrated embodiment, the fastening holes 11 are obtained along the extension of the upper, lower and lateral extension portions 10′, 10″, 10″′.

Once the positioning adapter body 8 is fixed to the shaped support body 2 at the seat 7, the ventilation unit 4 may be integrated into the dashboard 1, rigidly connecting the ventilation unit 4 to the positioning adapter body 8. In this regard, the positioning adapter body 8 has, along the circumferential surface which defines the main ring-shaped opening 15, respective grooves 20, 21 arranged for centering the ventilation unit 4 within the main opening 15. More specifically, the positioning adapter body 8 comprises a pair of lateral grooves 20, and a lower grooved portion 21, arranged to receive the support body 18.

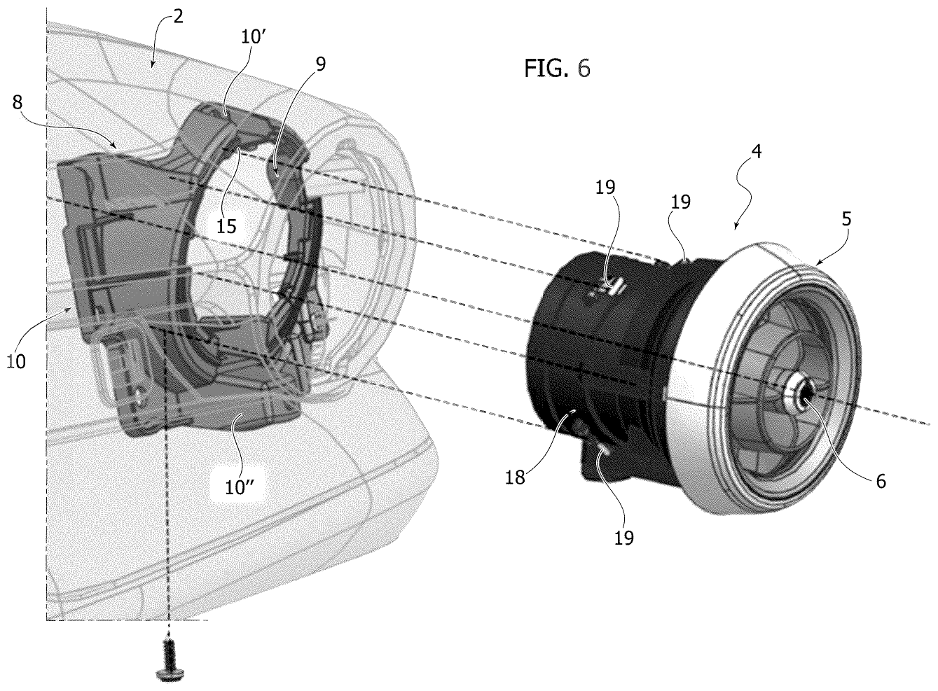

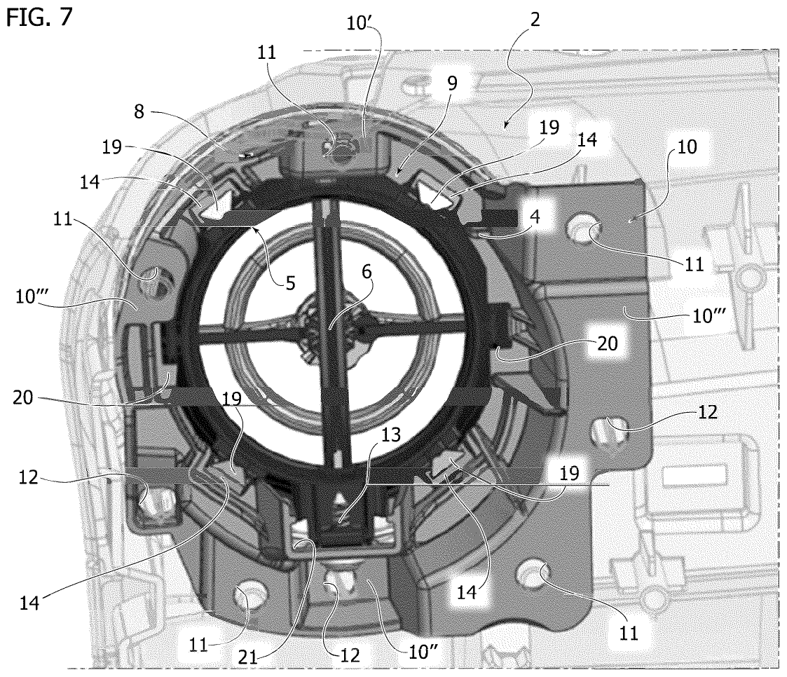

Furthermore, as illustrated in FIGS. 6, 7, the ventilation unit 4 comprises snap means 19 mutually engageable with respective abutment surfaces 14 of the positioning adapter body 8. The snap means 19 are obtained along the outer surface of the support body 18. In the embodiment illustrated in the drawings, the snap means 19 are flexible arms arranged along the surface of the support body 18, wherein the flexible arms have a central symmetry arrangement with respect to a pair of perpendicular main axes of the body 18, with four flexible arms arranged substantially equally spaced along the cylindrical surface of the support body 18.

Thanks to the characteristics indicated above, the ventilation unit 4 is constrained to the dashboard 1 and to the positioning adapter body 8 along three mutually orthogonal directions, in particular along the axial direction of the ventilation units 4 thanks to the welding points made at the holes 11. along a vertical direction thanks to the lower groove 21 and along a horizontal direction from one side of the passenger compartment to the other thanks to the lateral grooves 20, as well as thanks to the snap means 19.

According to a further preferred characteristic of the invention, a fixing point 22 is obtained at the lower grooved portion 21 for the arrangement of safety fixing means 13 arranged to further constrain a lower portion of the ventilation unit 4. The fixing means 13 may comprise a safety screw. Thanks to this characteristic, if an airbag safety device integrated in the dashboard 1 is activated, the safety fixing means 13 guarantee locking of the vent 5 in its position, without the risk that the vent may come out of its seat 7 and hit a passenger.

Of course, the basic principles of the invention remaining the same, the construction details and embodiments may vary widely with respect to what has been described and illustrated purely by way of example, without thereby departing from the scope of the present invention as defined by the attached claims.

1. A motor-vehicle dashboard, comprising:
a shaped support body provided with at least one fixing seat for positioning and fixing a ventilation unit arranged for providing an airflow towards the motor-vehicle interior,
wherein said ventilation unit comprises a support and flow-guide body, an air vent and adjustment means for adjusting the direction of the airflow,
a positioning adapter body rigidly connected to the shaped support body at the fixing seat, and arranged to selectively receive said ventilation unit,
wherein the positioning adapter body is a ring-shaped support flange comprising a main opening and a plurality of fastening and support elements for rigidly and coaxially connecting the positioning adapter body to the seat and the ventilation unit to the positioning adapter body, so that the support and flow-guide body protrudes inwards of the dashboard, through the main opening of the positioning adapter body,
wherein the positioning adapter body comprises a main ring portion from which extend a plurality of extension portions provided with said fastening and support elements,
wherein the positioning adapter body comprises respective grooves provided along the circumferential surface defining the main opening and arranged for centering the ventilation unit within the main opening,
wherein the positioning adapter body comprises a plurality of centering holes along the extension portions, arranged to selectively receive respective centering elements of the support body,
wherein the positioning adapter body comprises a plurality of fastening holes arranged to receive respective fastening elements of the support body.
wherein the positioning adapter body defines an abutment and fixing surface for the air vent, so as to enable assembling of ventilation units of the same type on different dashboards defining different dimensions and installation spaces.

2. A motor-vehicle dashboard according to claim 1, wherein the extension portions have respective front surfaces arranged in offset positions with respect to the surface defining the main ring portion.

3. A motor-vehicle dashboard according to claim 1, wherein the main ring portion comprises a plurality of reinforcing ribs and seats arranged to receive the support and flow-guide body of the air vent.

4. A motor-vehicle dashboard according to claim 1, wherein the positioning adapter body comprises upper and lower extension portions, wherein the lower extension portion comprises a body substantially protruding towards the outer surface of the shaped support body, and lateral extension portions so as to form a single continuous body with extension portions arranged around the ring portion.

5. A motor-vehicle dashboard according to claim 4, wherein the centering holes are made at the lower and lateral extension portions, wherein the lower extension portion comprises a central centering hole and each of the lateral portions have a further centering hole.

6. A motor-vehicle dashboard according to claim 4, wherein the fastening elements are welded to the positioning adapter body, at the fastening points obtained along the extension of the upper, lower and lateral extension portions

7. A motor-vehicle dashboard according to claim 1, wherein said grooves comprises a pair of lateral grooves, and a lower grooved portion, arranged to receive the support body.

8. A motor-vehicle dashboard according to claim 1, wherein the ventilation unit comprises snap-fit means formed along the outer surface of the support and flow-guide body, mutually engageable with respective abutment surfaces of the positioning adapter body.

9. A motor-vehicle dashboard according to claim 7, wherein a fixing point is provided at the lower grooved portion for the provision of safety fixing means configured to further constrain a lower portion of the ventilation unit to the adapter body, in order to ensure locking of the air vent.

10. A method for assembling a motor-vehicle dashboard according to claim 1, comprising the following steps:
providing a shaped support body comprising at least one fixing seat for positioning and fixing a ventilation unit arranged for providing an airflow towards the motor-vehicle interior,
providing said ventilation unit and said positioning adapter body,
assembling the adapter body to the shaped support body, following a foaming method to produce the shaped body,
rigidly connecting the ventilation unit to the positioning adapter body, so as to lock the air vent along three mutually orthogonal directions, within the main opening of the adapter body fixed within the seat.
